(19) United States
(12) Patent Application Publication
(10) Pub. No.: US 2007/0157267 A1
(43) Pub. Date: Jul. 5, 2007

(54) Techniques to improve time seek operations

(75) Inventor: Alex A. Lopez-Estrada, Chandler, AZ (US)

Correspondence Address: KACVINSKY LLC;C/O INTELLEVATE, P.O. BOX 52050, MINNEAPOLIS, MN, 55402, US

(73) Assignee: Intel Corporation

(21) Appl. No.: 11/322,436

(22) Filed: Dec. 30, 2005

(51) Int. Cl. H04N 7/173

(52) U.S. Cl. 725/90; 725/87; 725/88

(57) ABSTRACT

Techniques to improve time seek operations are described. An apparatus may include a digital media server having a media content seek module. The media content seek module may perform video sequence header alignment for media content in response to a time seek request. Other embodiments are described and claimed.

### BACKGROUND

Use of digital media is becoming increasingly common. In home networks, for example, devices are increasingly able to handle digital content. As a result, usage models available to home network users are becoming more sophisticated and these users are demanding more powerful capabilities to share digital content throughout the house. Ease of use is still, however, imperative to users in this home network environment.

One critical feature for any usage model in a home network environment is the ability to manipulate media content. In addition to normal playback operations such as Play, Pause and Stop, media content may be manipulated using a “trick mode” or “trick play.” Trick mode allows a user to manipulate content with actions such as fast forward, fast reverse, time seek, jumping to a scene in a movie, and so forth. Users of media content players such as video home system (VHS) and digital versatile disc (DVD) players have become accustomed to these features and therefore expect to have some, if not all, of this functionality available to them in other usage models. Although it is currently possible for users to seek through digital content and perform basic trick play such as fast forward and/or fast rewind, these features are far from advanced and not very user friendly. Consequently there may be a need for improvements in such techniques.

### BRIEF DESCRIPTION OF THE DRAWINGS

FIG. 1 illustrates one embodiment of a media processing system.

FIG. 2 illustrates one embodiment of a first sequence of video frames.

FIG. 3 illustrates one embodiment of a second sequence of video frames.

FIG. 4 illustrates one embodiment of a first media content seek operation.

FIG. 5 illustrates one embodiment of a second media content seek operation.

FIG. 6 illustrates one embodiment of a digital media server.

FIG. 7 illustrates one embodiment of a logic flow.

FIG. 8 illustrates one embodiment of a third media content seek operation.

FIG. 9 illustrates one embodiment of a fourth media content seek operation.

### DETAILED DESCRIPTION

Various embodiments may be directed to techniques to improve time seek operations. For example, various embodiments may be directed to techniques to improve time seek operations for streaming audio/video signals as used by digital home systems, such as digital cable systems, digital satellite systems, video on demand (VOD) systems, and so forth. The time seek operations may be implemented in response to trick mode or trick play operations, such as fast forward, fast reverse, time seek, jumping to a scene in a movie, and so forth. Rather than imposing restrictions on the encoder for proper seek alignment and operation, various embodiments may implement time seek operations at a media content server. In this manner, time seek operations are not dependent on the encoded content, but rather on a server implementation, making it a more attractive solution for legacy content and a wider array of sources that do not necessarily meet the encoding guidelines set forth by various media processing standards.

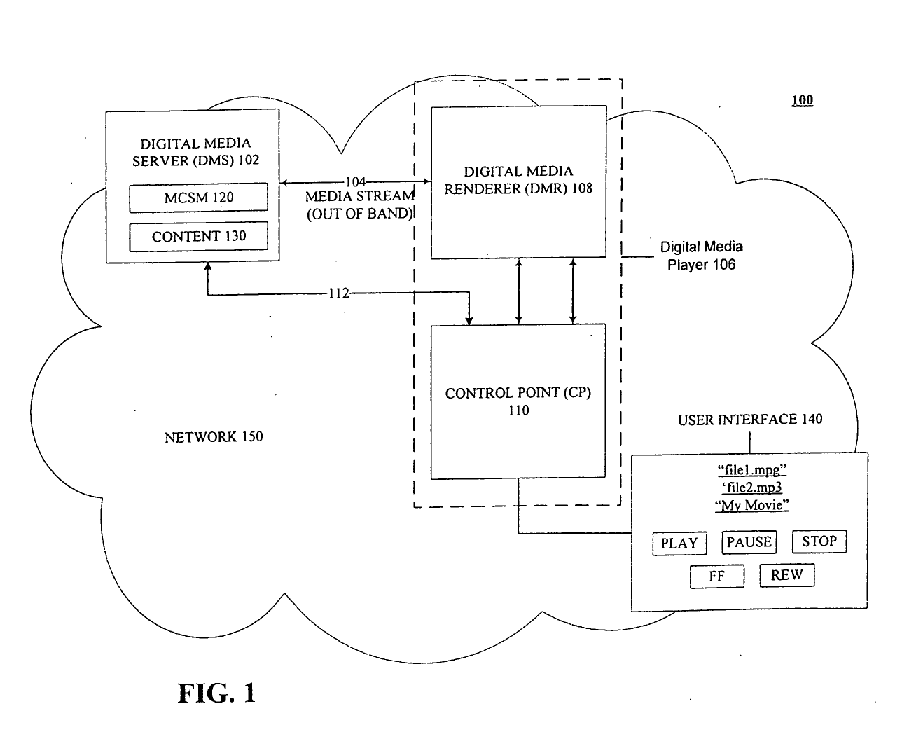

FIG. 1 illustrates one embodiment of a media processing system. FIG. 1 illustrates a block diagram of a media processing system 100. In one embodiment, for example, media processing system 100 may comprise multiple nodes. A node may comprise any physical or logical entity for processing and/or communicating information in media processing system 100 and may be implemented as hardware, software, or any combination thereof, as desired for a given set of design parameters or performance constraints. Although FIG. 1 is shown with a limited number of nodes in a certain topology, it may be appreciated that media processing system 100 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), television, a digital television, a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a processor, and so forth. The embodiments are not limited in this context.

In various embodiments, media processing system 100 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), and so forth. For example, the described embodiments may be arranged to operate in accordance with standards for media processing, such as the National Television Systems Committee (NTSC) standard, the Advanced Television Systems Committee (ATSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the DVB Satellite (DVB-S) broadcasting standard, the DVB Cable (DVB-C) broadcasting standard, the Open Cable standard, the Society of Motion Picture and Television Engineers (SMPTE) Video-Codec (VC-1) standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of media processing system 100 may be arranged to communicate, manage or process different types of information, such as media information and control information. Examples of media information may generally include any data or signals representing content meant for a user, such as media content, voice information, video information, audio information, image information, textual information, numerical information, alphanumeric symbols, graphics, and so forth. Control information may refer to any data or signals representing commands, instructions or control words meant for an automated system. For example, control information may be used to route media information through a system, to establish a connection between devices, instruct a node to process the media information in a predetermined manner, monitor or communicate status, perform synchronization, and so forth. The embodiments are not limited in this context.

In various embodiments, media processing system 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, media processing system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The wired communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, media processing system 100 may include one or more wireless nodes arranged to communicate information over one or more types of wireless communication media. An example of wireless communication media may include portions of a wireless spectrum, such as the RF spectrum. The wireless nodes may include components and interfaces suitable for communicating information signals over the designated wireless spectrum, such as one or more antennas, wireless transmitters/receivers (“transceivers”), amplifiers, filters, control logic, antennas, and so forth. The embodiments are not limited in this context.

In various embodiments, media processing system 100 may include one or more media source nodes 102-1-n. Media source nodes 102-1-n may comprise any media source capable of sourcing or delivering media information and/or control information to media processing node 106. More particularly, media source nodes 102-1-n may comprise any media source capable of sourcing or delivering digital audio and/or video (AV) signals to media processing node 106. Examples of media source nodes 102-1-n may include any hardware or software element capable of storing and/or delivering media information, such as a DVD device, a VHS device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, television system, digital television system, set top boxes, personal video records, server systems, computer systems, personal computer systems, digital audio devices (e.g., MP3 players), and so forth. Other examples of media source nodes 102-1-n may include media distribution systems to provide broadcast or streaming analog or digital AV signals to media processing node 106. Examples of media distribution systems may include, for example, Over The Air (OTA) broadcast systems, terrestrial cable systems (CATV), satellite broadcast systems, and so forth. It is worthy to note that media source nodes 102-1-n may be internal or external to media processing node 106, depending upon a given implementation. The embodiments are not limited in this context.

In various embodiments, media processing system 100 may comprise a media processing node 106 to connect to media source nodes 102-1-n over one or more communications media 104-1-m. Media processing node 106 may comprise any node as previously described that is arranged to process media information received from media source nodes 102-1-n. In various embodiments, media processing node 106 may comprise, or be implemented as, one or more media processing devices having a processing system, a processing sub-system, a processor, a computer, a device, an encoder, a decoder, a coder/decoder (codec), a filtering device (e.g., graphic scaling device, deblocking filtering device), a transformation device, an entertainment system, a display, or any other processing architecture. The embodiments are not limited in this context.

In various embodiments, media processing system 100 may comprise a digital home architecture designed for use by consumers. Alternatively, media processing system 100 may comprise a digital office architecture. Consequently, media processing system 100 may be implemented in accordance with various standards, protocols, or guidelines designed to enable interoperability between various (potentially heterogeneous) media devices and ease of use for consumers. Examples of such standards may include the Universal Plug and Play (UPnP) standard, the Networked Media Product Requirements (NMPR) standard developed by Intel® Corporation, Version 2.1, 2005, the Digital Living Network Alliance (DLNA) standard, Version 1.0, 2005, and so forth. These standards each attempt to anticipate common usage models in the digital home and define protocols and guidelines to enable interoperability and ease of use within these models. Although some embodiments may be described using the DLNA and/or UPnP standards by way of example, it may be appreciated that other media standards related to streaming media content over a network may be used as desired for a given implementation. The embodiments are not limited in this context.

In one embodiment, for example, media processing system 100 may be implemented as part of a digital home architecture using the DLNA and/or UPnP standards. When implemented in accordance with the DLNA standard, for example, media source node 102 may be implemented as a digital media server (DMS), and media processing node 106 may be implemented as a digital media player (DMP). When implemented in accordance with the UPnP standard, for example, DMP 106 may be further separated to include a digital media renderer (DMR) 108 and a control point (CP) 110. DMS 102 and DMP 106 may communicate media and control information over communication media 104 (e.g., wired or wireless). DMS 102 and CP 110 may communicate media and control information over communication media 112 (e.g., wired or wireless). The embodiments are not limited in this context.

The DLNA and UPnP standards may be directed to different aspects of a digital home architecture. For example, UPnP deals primarily with the communication aspects of the media devices. It defines standard services and associated actions that a certain device needs to implement in order to be “seen” and “talk” to other devices. DLNA takes interoperability one step further and defines baseline capabilities that the media devices need to support in order to be conformant. This may include baseline format profiles for typical audio and video codecs. They also extend standards definitions to deal with the new usage models, as for example, extending the hypertext transport protocol (HTTP) to handle trick modes. The baseline media format for audio/visual (A/V) content is MPEG-2 system streams encapsulating MPEG-2 video with MPEG-2, AC3 or LPCM audio, although other media formats may be used as desired for a given implementation.

In accordance with the UPnP standard, DMS 102 may operate as the source of media content 130 and DMP 106 may operate as the sink that consumes media content 130. CP 110 may be arranged to discover devices in the network, negotiate formats between DMS 102 and DMP 106, and establish a connection between the devices. CP 110 may additionally include a user interface 140. User interface 140 may allow a user to perform various standard control mode operations and trick mode operations for media content 130. Examples of standard control mode operations may include Play, Stop and Pause operations. Examples of trick mode operations may include Fast Forward (FF), Rewind (REW), fast reverse, time seek, jumping to a scene in a movie, and so forth. Discovery and negotiation operations may be performed using UPnP specified protocols, such as the IETF Simple Service Discovery Protocol (SSDP) and the Extensible Markup Language (XML) Protocol Working Group Simple Object Access Protocol (SOAP). Once a connection is established, media content 130 may be streamed directly from DMS 102 to DMP 106 over media 104 using various out-of-band non-UPnP specific protocols, such as HTTP, for example. After the connection is established, CP 110 may perform various transport control operations, such as standard control mode operations (e.g., Play, Pause and Stop) and trick mode operations (e.g., FF and REW). CP 110 may perform such transport control operations in accordance with standard defined SOAP actions. Device capabilities (e.g., formats for each device), however, is generally outside the scope of the UPnP standard. Consequently, there is no guarantee that two UPnP devices will successfully interoperate. Accordingly, the DLNA standard may be used to improve interoperability between the various media devices of media processing system 100.

In accordance with the DLNA standard, media processing system 100 may define baseline device capabilities for DMS 102 and DMP 106 to improve interoperability between such devices. The DLNA standard currently defines only two types of devices, including DMS 102 and DMP 106. In UPnP terms, DMP 106 may be further defined to comprise CP 110 coupled to DMR 108. The communication between DMR 108 and CP 110 is therefore not defined by the DLNA standard since these elements may be implemented in a single device, hardware component, software component, or combination of hardware/software components. Future versions of the DLNA standard, however, may separate DMR 108 from CP 110 similar to the current UPnP scheme, or may alternatively identify new types of devices. The embodiments may encompass such future enhancements to the DLNA standard.

In general operation, DMS 102 may communicate or stream media content such as A/V content to DMP 106 over media transport 104. DMS 102 may include a stream encoder that receives digital “raw” audio and video at the encoding pipeline, compresses the A/V data, forms the compressed A/V data into packets, and multiplexes the A/V into a single bitstream useful for transmission over communications medium 104. Similarly, DMP 106 may receive the encoded stream, demultiplex the encoded A/V signals, depacketize the A/V compressed data, and decompress the compressed A/V data into the original A/V content.

In one embodiment, for example, the media content may be encoded and decoded in accordance with the MPEG-2 standard. The MPEG-2 standard defines two types of system streams, to include Program Streams (PS) and Transport Streams (TS). The PS format is used for more reliable environments such as storing/retrieving from local media. This is the format typically used by a DVD device. The TS format is used for more error prone environments by providing increased metadata redundancy for error recovery and smaller packets. This is the format typically used for satellite and terrestrial broadcast (e.g., ATSC).

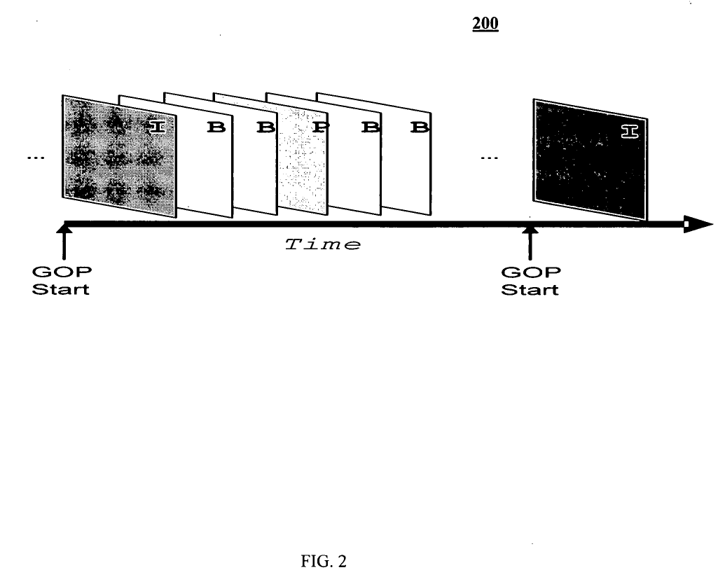

Although MPEG-2 defines the format of the bitstream, MPEG-2 does not typically impose any requirements on the periodicity and regularity of certain packets required for synchronization between DMS 102 and DMP 106. Further, MPEG-2 does not typically impose requirements on the underlying audio and video compression structure other than the bitstream definition. Some of the structures, specifically defined for video sources, may be described in more detail with reference to FIG. 2.

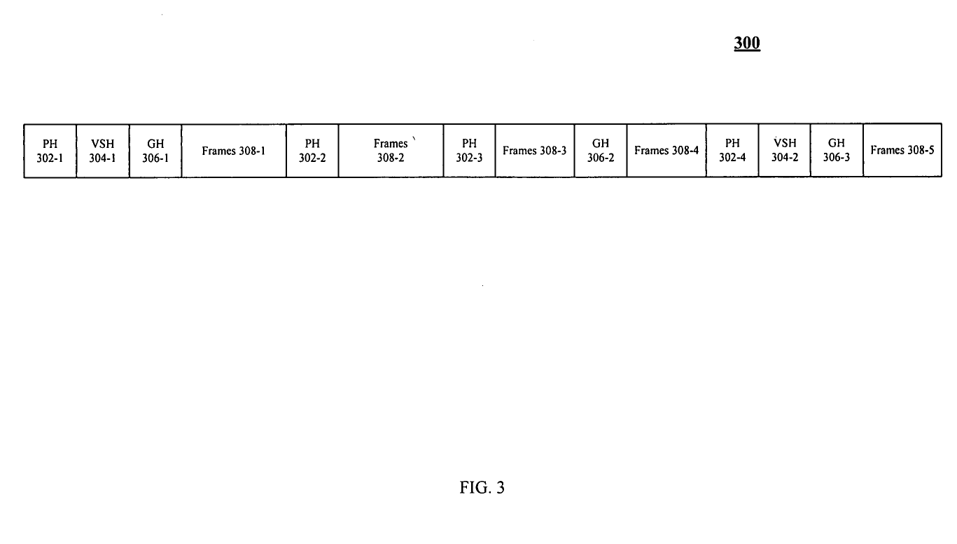

FIG. 2 illustrates one embodiment of a first sequence of video frames. FIG. 2 illustrates a media stream 200 of media content 130 as encoded by DMS 102. As shown in FIG. 2, media stream 200 may include various frames of media content 130. A Group of Pictures (GOP) marks the beginning of a series of encoded frames that do not have any dependencies on previous frames. Thus, the start of a GOP is typically used for random access into media stream 200. The GOP may have various frame types, such as an Index (I) frame, followed by predictive (P) frames and bi-directional predictive (B) frames. The GOP may comprise one portion of the MPEG-2 system stream, as described in more detail with reference to FIG. 3.

FIG. 3 illustrates one embodiment of a second sequence of video frames. FIG. 3 illustrates a media stream 300. Media stream 300 may be representative of an MPEG-2 system stream. As shown in FIG. 3, media stream 300 may include a packet header (PH) 302-1-q, video sequence header (VSH) 304-1-r, GOP header (GH) 306-1-s, and frames 308-1-t. PH 302-1-q may include the TS or PS headers plus additional packetization, such as present in a packetized elementary stream (PES). VSH 304-1-r may comprise the MPEG-2 video sequence header. GH 306-1-s may include the GOP header. Frames 308-1-t may include the various encoded frames (e.g., I frames, P frames, and B frames) of media stream 200 as described with reference to FIG. 2. As shown in FIG. 3, it may be appreciated that the GH 306-1-s are not necessarily aligned, and furthermore, a VSH 304-1-r is not necessarily present on every GOP start. In addition, the GH 306-1-s are not necessarily encoded periodically.

In one embodiment, for example, VSH 304-1-r may comprise an MPEG-2 video sequence header, although the embodiments are not limited in this respect. VSH 304-1-r may be specified at the video pack layer. VSH 304-1-r may include one or more video sequence parameters that may provide useful information for video parameter refresh as performed by DMP 106 and/or DMR 108. Examples for the video sequence parameters may include horizontal_size_value (in pixels), vertical_size_value (in pixels), aspect_ratio_information (e.g., 4:3 aspect ratio, 16:9 aspect ratio, and so forth), frame_rate_code (e.g., 30 frames per second, 24 frames per second, and so forth), bit_rate_value, intra_quantiser_matrix, non_intra_quantiser_matrix, and so forth. Some or all of these parameters may be needed for proper decoding operations.

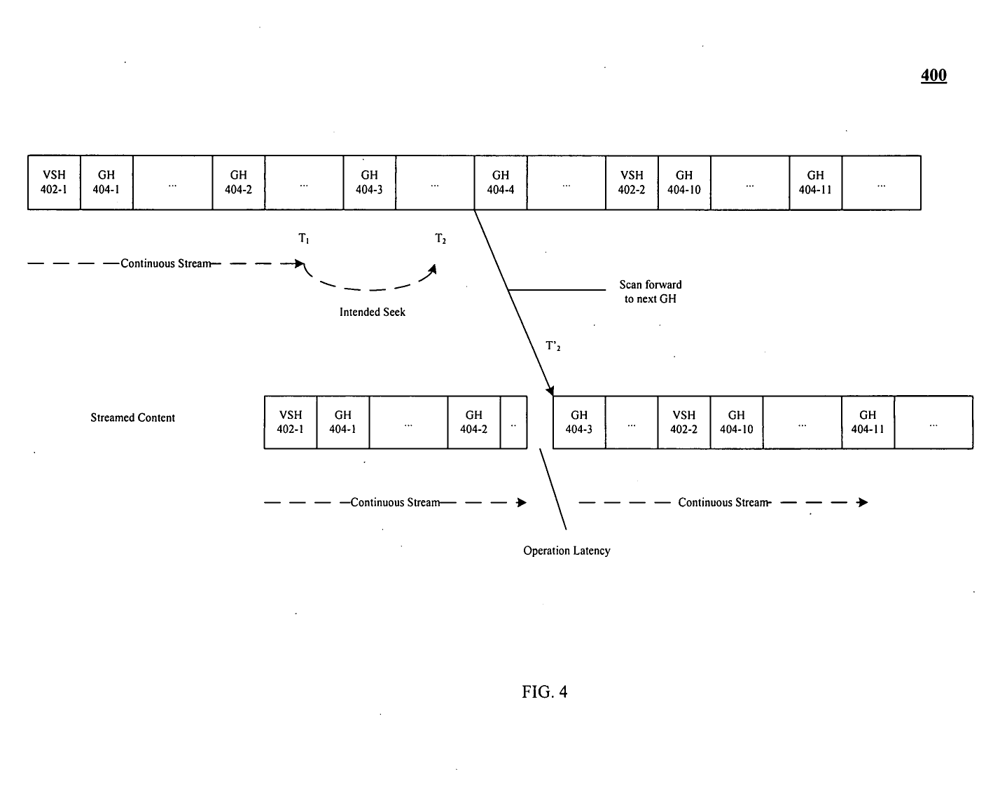

Conventional techniques to perform time seek operations on an A/V media stream such as media stream 300 may be unsatisfactory in a network environment for a number of reasons. For example, one technique is to download and cache content. For devices with recording capabilities (e.g., with a hard disk or persistent storage), it is possible to cache the content locally to the media, which then enables seek operations as file system input/output (I/O) operations. This technique, however, does not work well for thin clients without persistent media or devices with lower memory capacity. Another technique may use byte ranges. On the decoding end, the device requests a specific range to be streamed to achieve a seek operation. This usually assumes that the decoding/rendering endpoint has information that translates a time-based seek into a byte range. This also implies that the rendering endpoint can synchronize or adjust itself to the byte range requested. Yet another technique may include a time seek range, which is specific to DLNA systems. The DLNA standard defines a time seek HTTP header that allows a rendering end point (e.g., a DMP) to specify where to seek within the media stream. The DMS is then responsible of determining a byte position within the stream that corresponds to the specified time. The limitations of the DLNA time seek range techniques may be described in more detail with reference to FIG. 4.

FIG. 4 illustrates one embodiment of a first media content seek operation. FIG. 4 illustrates a first time seek range technique as defined by the DLNA standard. In order to accomplish a time seek using a time seek range technique, DLNA imposes certain restrictions for allowing “seekable” media. Furthermore, these restrictions are imposed only on certain coding profiles, such as MPEG_PS_NTSC, MPEG_PS_PAL and the TS flavors (e.g., MPEG_TS_xxx). One issue with interoperable seek solutions is the restrictions imposed on the encoding source, not guaranteeing that every source content will be seekable. For example, there are no restrictions imposed on transport stream content server behavior with regards to refreshing video parameters through video sequence headers.

As an example, assume that the user is currently watching a movie at Time T₁ and desires to seek to T₂. If position T₂ falls within the same video sequence as T₁ (e.g., uses the same video parameters), a smart serving endpoint may decide to start at the closer GOP header (e.g., GH 404-3) at T′₂ to ensure random seek alignment. If the serving endpoint does not align to GH 404-3, however, it is the responsibility of the rendering endpoint to do the scan to re-align to a closer GH.

This technique can result in wasted network and processing bandwidth. For example, assume a media player is trying to seek at random positions within a bitstream. If the server does not align to a GH or VSH, the player will not accurately predict the byte offset position, which may cause the player to discard non-useful data scanning forward for the next synchronization point, or requesting multiple ranges to find a synchronization point. The extra bandwidth used for unwanted data could be saved for other network traffic if the player can be guaranteed that the serving endpoint will do the synchronization. Moreover, the blind guess-and-seek results in unnecessary processing cycles.

In addition to wasting network and processing bandwidth, this technique may provide a poor user experience. From a user perspective if the media player has to scan backward or forward for synchronization, it will be reflected as unnecessary operation latency. Further, the synchronization point may not be close to the user's requested time seek position, especially if the player “just missed” the last synchronization point when it guessed the synchronization point position. A second condition that results in poor user experience is time based seek granularity. Depending on the frequency and periodicity of synchronization point headers (e.g., GH or VSH), the available synchronization points will not provide the user with enough granularity to find desired navigation points within the encoded bitstream.

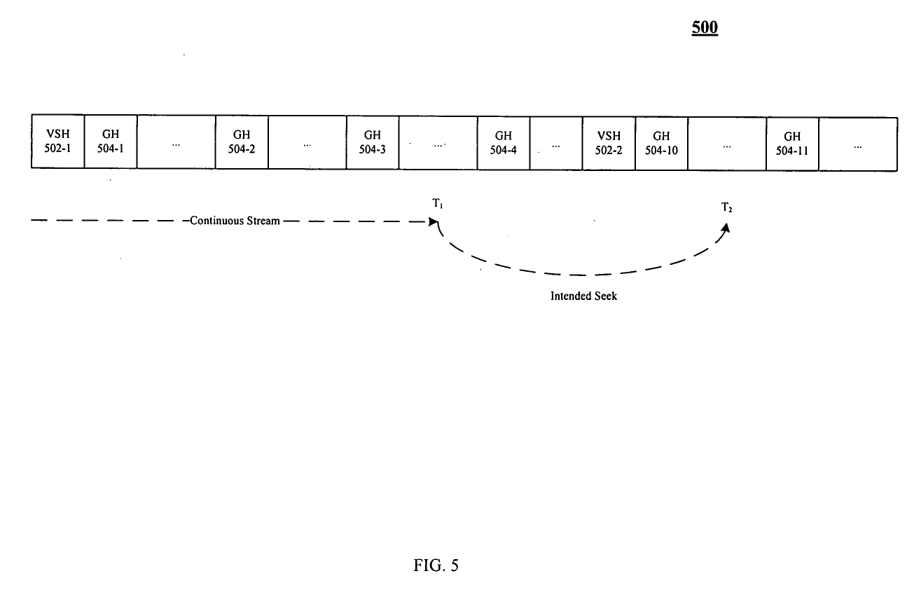

The undesired results of network inefficiency and poor user experience may be further exacerbated when T₂ falls outside of the current video sequence range. This may be described in more detail with reference to FIG. 5.

FIG. 5 illustrates one embodiment of a second media content seek operation. FIG. 5 illustrates a second time seek range technique as defined by the DLNA standard. More particularly, FIG. 5 illustrates the case where T₂ is outside the current video sequence range. In this case, there is no guarantee that the server will scan backward or forward to the next video sequence header. Moreover, if the rendering endpoint decides to scan forward to the next available VSH the difference between the actual seek time and the desired seek time may be too large (e.g., the VSH may be too far apart). This behavior may result in a very poor user experience and low seek granularity from a user perspective.

Various embodiments may attempt to solve these and other problems. Various embodiments may be directed to managing media content. For example, various embodiments may be directed to manipulating media content, particularly for certain trick mode operations that include time seek operations. The following description assumes the use of an UPnP scheme but the embodiments are not so limited. Thus, for example, alternate embodiments may be implemented wherein CP 110 and DMR 108 are integrated as a single device or process (e.g., a DMP in DLNA terms) and/or using non-UPnP protocols. Additionally, although the following description assumes audio/video content only, the embodiments are not so limited and may be applicable to any form and/or combination of digital content.

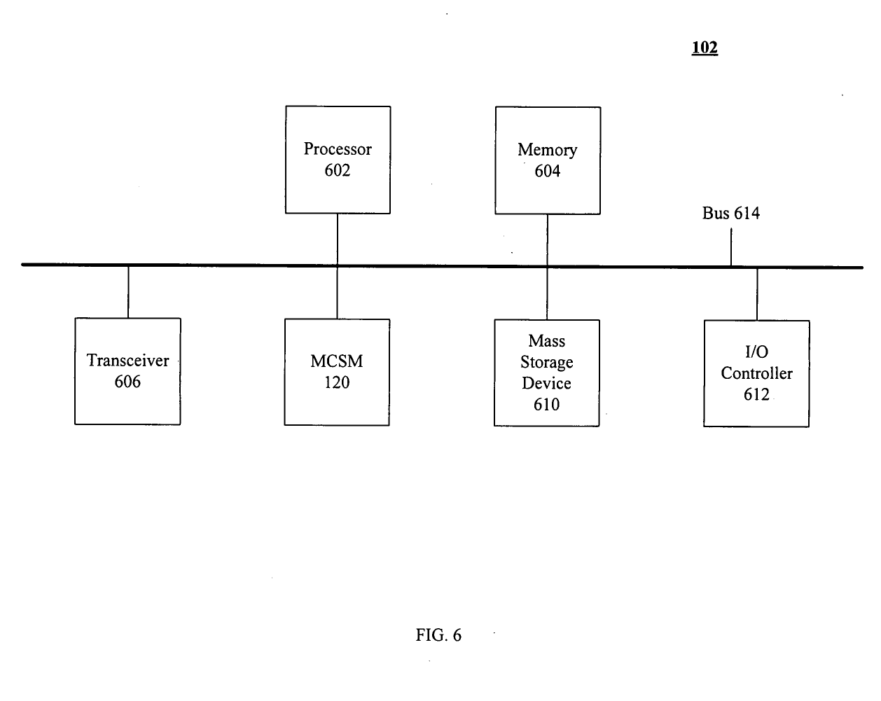

In one embodiment, for example, DMS 102 may include a media content seek module (MCSM) 120. MCSM 120 may be arranged to perform video sequence header alignment for media content in response to a time seek request. MCSM 120 may perform group of picture header alignment if the time seek request includes a time value that is within a first video sequence. MCSM 120 may perform the video sequence header alignment if the time seek request includes a time value that is within a second video sequence. MCSM 120 may perform the video sequence header alignment if the time value is less than a predefined number of time units (e.g., seconds) of a video sequence header. If the time value is more than a predefined number of time units of a video sequence header, MCSM 120 may perform video sequence header retransmission. DMS 102 in general, and MCSM 120 in particular, may be described in more detail with reference to FIG. 6.

FIG. 6 illustrates one embodiment of a digital media server. FIG. 6 illustrates a block diagram of a digital media server suitable for use with media processing system 100 as described with reference to FIG. 1, such as DMS 102. The embodiments are not limited, however, to the example given in FIG. 6.

As shown in FIG. 6, DMS 102 may comprise multiple elements. One or more elements may be implemented using one or more circuits, components, registers, processors, software subroutines, modules, or any combination thereof, as desired for a given set of design or performance constraints. Although FIG. 6 shows a limited number of elements in a certain topology by way of example, it can be appreciated that more or less elements in any suitable topology may be used in DMS 102 as desired for a given implementation. The embodiments are not limited in this context.

In various embodiments, DMS 102 may include a processor 602. Processor 602 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 602 may be implemented as a general purpose processor, such as a processor made by Intel® Corporation, Santa Clara, Calif. Processor 602 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, DMS 102 may include a memory 604 to couple to processor 602. Memory 604 may be coupled to processor 602 via communications bus 614, or by a dedicated communications bus between processor 602 and memory 604, as desired for a given implementation. Memory 604 may be implemented using any machine-readable or computer-readable media capable of storing data, including both volatile and non-volatile memory. For example, memory 604 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 604 may be included on the same integrated circuit as processor 602, or alternatively some portion or all of memory 604 may be disposed on an integrated circuit or other medium, for example a hard disk drive, that is external to the integrated circuit of processor 602. The embodiments are not limited in this context.

In various embodiments, DMS 102 may include a transceiver 606. Transceiver 606 may be used when DMS 102 is implemented as wireless device. Transceiver 606 may be any radio transmitter and/or receiver arranged to operate in accordance with a desired wireless protocols. Examples of suitable wireless protocols may include various wireless local area network (WLAN) protocols, including the IEEE 802.xx series of protocols, such as IEEE 802.11a/b/g/n, IEEE 802.16, IEEE 802.20, and so forth. Other examples of wireless protocols may include various wireless wide area network (WWAN) protocols, such as Global System for Mobile Communications (GSM) cellular radiotelephone system protocols with General Packet Radio Service (GPRS), Code Division Multiple Access (CDMA) cellular radiotelephone communication systems with 1xRTT, Enhanced Data Rates for Global Evolution (EDGE) systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Other suitable protocols may include Ultra Wide Band (UWB), Digital Office (DO), Digital Home, Trusted Platform Module (TPM), ZigBee, and other protocols. The embodiments are not limited in this context.

In various embodiments, DMS 102 may include one or more mass storage devices 610. Examples of mass storage devices 610 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, DMS 102 may include one or more I/O adapters 612. Examples of I/O adapters 612 may include Universal Serial Bus (USB) ports/adapters, IEEE 1394 Firewire ports/adapters, and so forth. When implemented as a wired device, I/O adapter 612 may comprise a network interface and associated physical connectors. The embodiments are not limited in this context.

In various embodiments, DMS 102 may include one or more modules. The modules may comprise, or be implemented as, one or more systems, sub-systems, processors, devices, machines, tools, components, circuits, registers, applications, programs, subroutines, or any combination thereof, as desired for a given set of design or performance constraints. The embodiments are not limited in this context.

In one embodiment, for example, DMS 102 may include MCSM 120. MCSM 120 may perform various time seek operations for media content 130 streamed between DMS 102 and DMP 106. The time seek operations may be implemented in response to trick mode or trick play operations (e.g., FF and REW), as received from CP 110 via user interface 140. In various embodiments, MCSM 120 may be implemented as software executed by processor 602, dedicated hardware such as a media processor or circuit, or a combination of both. The embodiments are not limited in this context.

MCSM 120 may be arranged to operate with, among others, two types of MPEG-2 streams, to include PS and TS. Rather than imposing restrictions on the encoder for proper seek alignment and operation, MCSM 120 of DMS 102 may implement a seek operation and guarantee an adequate behavior on the rendering end point, such as DMP 106. In this manner, seek operations are not dependent on the encoded content, but rather on a server implementation, making it a more attractive solution for legacy content and a wider array of sources that not necessarily meet the encoding guidelines set forth by the DLNA standard. MCSM 120 may be arranged to handle both PS and TS content.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

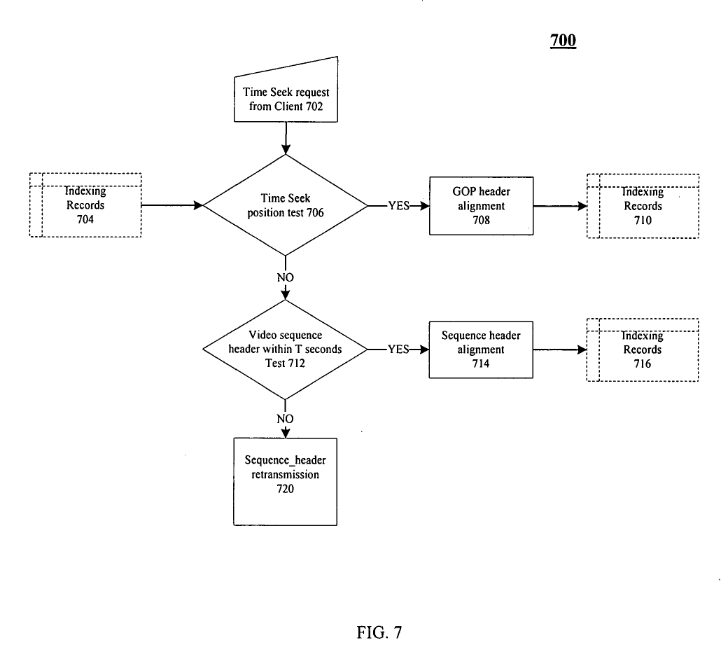

FIG. 7 illustrates one embodiment of a logic flow. FIG. 7 illustrates a logic flow 700. Logic flow 700 may be representative of the operations executed by one or more embodiments described herein, such as media processing system 100, DMS 102, and/or MCSM 120. As shown in logic flow 700, a time seek request from a client may be received at block 702. A first determination may be made as to whether the time seek request is within a range of a first video sequence or a second video sequence at block 706. GOP header alignment operations may be performed at block 708 if the time seek request is within a range for the first video sequence. If the time seek request is not within the first video sequence, or stated positively is within a second video sequence, a second determination may be made as to whether the time seek request includes a time value that is less than a predefined number of time units of a video sequence header at block 712. If the time value is less than the predefined number of time units, then video sequence header alignment operations may be performed at block 714. If the time value is more than the predefined number of time units, then video sequence header retransmission operations may be performed at block 720. Indexing records may be used or updated at blocks 704, 710 or 716 to assist in other operations, such as the operations associated with block 706, for example. The embodiments are not limited in this context.

The embodiments described with reference to FIGS. 1-7 may be described in more detail by way of example. As described with reference to FIG. 7, a time seek request from a client may be received at block 702. Examples for a client may include DMP 106, DMR 108, or CP 110. A user may initiate the time seek request using user interface 140 of CP 110. For example, a user may select FF to seek A/V frames that are at a future time in the streaming content media 130. The time seek request may be received by DMS 102, for example. MCMS 120 of DMS 102 may determine whether the requested seek is within a range of a current video sequence (e.g., first video sequence) or outside the range of the current video sequence (e.g., second video sequence) at block 706. MCMS 120 may accelerate this determination using indexing records received at block 704. The indexing records may contain, for example, a byte position for the various required indices, such as video sequence byte offsets and GOP header byte offsets.

If the time seek request is within a range for the first video sequence, MCMS 120 may perform GOP header alignment operations at block 708 in an effort to align the seek response to a “closer” GOP header. The indexing records may be updated at block 710.

If the seek request falls outside the range of the current video sequence, however, MCMS 120 attempts to calculate how “close” in time is the “closest” video sequence header. MCMS 120 may determine whether the time seek request includes a time value that is less than a predefined number of time units of a video sequence header at block 712. For example, the predefined number of time units may comprise T seconds, where T is any positive integer.

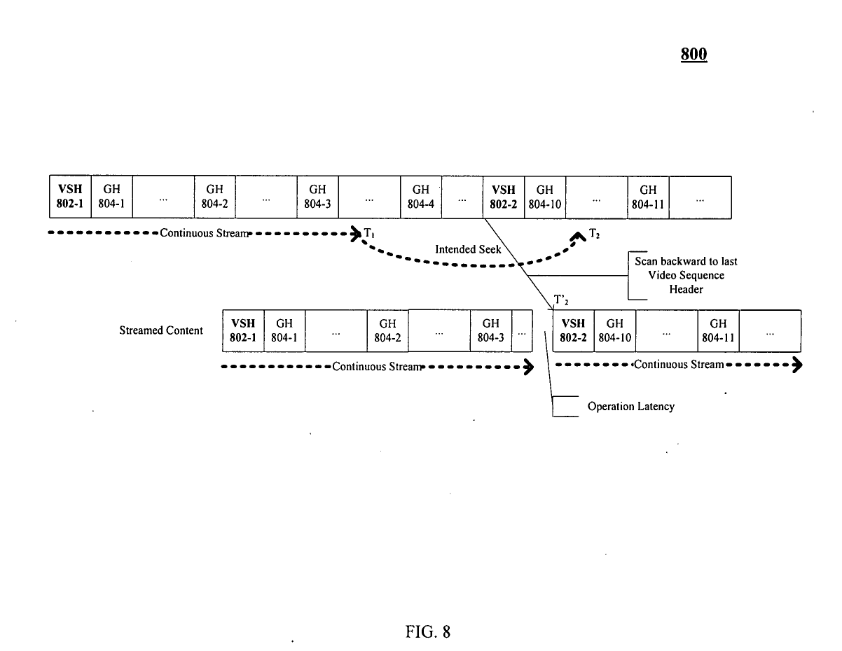

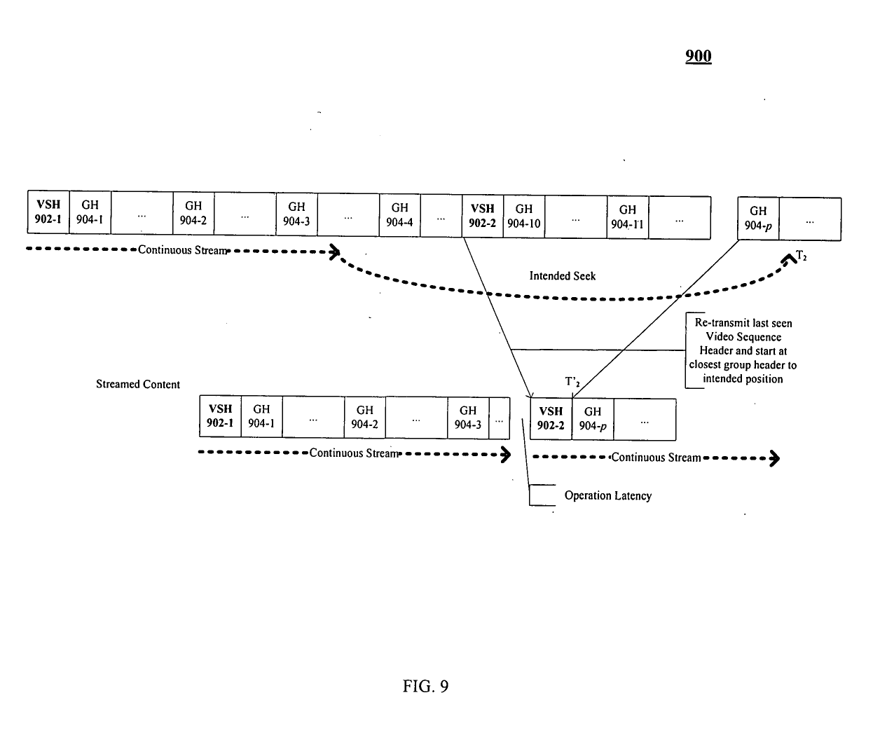

If the time value is within a pre-configured time delta (ΔT seconds), then MCMS 120 may perform video sequence header alignment operations at block 714 in an attempt to align the seek response to the closest video sequence header. MCMS 120 may update the indexing records at block 716. If the time value is more than the predefined number of time units, however, then MCMS 120 may perform video sequence header retransmission operations at block 720. The video sequence header alignment operations and video sequence header retransmission operations may be described in more detail with reference to FIGS. 8 and 9.

FIG. 8 illustrates one embodiment of a third media content seek operation. FIG. 8 illustrates a media stream 800. Media stream 800 may be representative of an MPEG-2 system stream, similar to media streams 300, 400. Media stream 800 may include VSH 802-1-u, GH 804-1-v, as well as other media and control information (e.g., various encoded frames).

As shown in FIG. 8, media stream 800 may comprise a continuous stream of encoded media content from media content 130. When a time seek request is issued on DMS 102 at time T₁, MCMS 120 may perform a time seek for a time value of T₂. The time value of T₂, however, is outside of a first video sequence (e.g., current video sequence) as defined by VSH 802-1. The time value of T₂ is actually within a second video sequence as defined by VSH 802-2. The video sequence parameters of VSH 802-2 may differ from VSH 802-1. For example, VSH 802-1 may have the aspect_ratio_information parameter set to a 4:3 aspect ratio, while VSH 802-2 may have the aspect_ratio_information parameter set to a 16:9 aspect ratio. If DMS 102 sends a time seek response to the time seek request with media content that does not include VSH 802-2, DMP 106 and/or DMR 108 may be incapable of decoding the media content.

To avoid this problem, MCMS 120 may search for the closest VSH to T₂. If the “closest” sequence header is within a time delta of T seconds, MCMS 120 may scan backward or forward to the “closest” video sequence header packet. In the example shown in FIG. 8, the closest VSH to T₂ may comprise VSH 802-2. MCMS 120 may then send a time seek response having the VHS boundary of VSH 802-2, and the following portions of the continuous stream of media content 130, such as GH 804-10 et seq. Consequently, if T₂ is the desired requested time position, MCMS 120 of DMS 102 may provide media content from the actual returned position corresponding to T′₂. DMP 106 may keep a record of sequence headers for the content in order to know where these are located within the encoded bitstream to aid in alignment operations.

FIG. 9 illustrates one embodiment of a fourth media content seek operation. FIG. 9 illustrates a media stream 900. Media stream 900 may be representative of an MPEG-2 system stream, similar to media streams 300, 400 and 800. Media stream 900 may include VSH 902-1-w, GH 904-1-x, as well as other media and control information (e.g., various encoded frames).

As shown in FIG. 9, media stream 900 may comprise a continuous stream of encoded media content for media content 130. When a time seek request is issued on DMS 102 at time T₁, MCMS 120 may perform a time seek for a time value of T₂. The time value of T₂, however, is outside of a first video sequence (e.g., current video sequence) as defined by VSH 902-1. The time value of T₂ is actually within a second video sequence as defined by VSH 902-2. The video sequence parameters of VSH 902-2 may differ from VSH 902-1. If DMS 102 sends a time seek response to the time seek request with media content that does not include VSH 902-2, DMP 106 and/or DMR 108 may be incapable of decoding the media content.

To avoid this problem, MCMS 120 may search for the closest VSH to T₂. If the “closest” sequence header is within a time delta of T seconds, MCMS 120 may scan backward or forward to the “closest” video sequence header packet. In the example shown in FIG. 9, the closest VSH to T₂ may comprise VSH 902-2. VSH 902-2, however, may be greater than the time delta of T seconds. When a time seek request is issued on DMS 102, the requested position corresponds to a new video encoded with new sequence parameters, and the proximity of the closer VSH is more than the time delta of T seconds, MCMS 120 may send a time seek response carrying media content to a client containing the last seen VSH, followed by the packet aligned to GOP header closest to the requested position. As shown in FIG. 9, the last seen VSH at requested time T₂ is VSH 902-2. Since VSH 902-2 is outside of the pre-configured time delta, MCMS 120 may retransmit the packet with VSH 902-2, immediately followed by the closest GOP header, which in this case is GH 904-p. It is worthy to note that MCMS 120 can use index records to aid in the stream repackaging to achieve this result. These indexing records may contain the byte offset and the length of the VSH packets and/or GH packets.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising a digital media server having a media content seek module, said media content seek module to perform video sequence header alignment for media content in response to a time seek request.

2. The apparatus of claim 1, said media content seek module to perform group of picture header alignment if said time seek request includes a time value that is within a first video sequence.

3. The apparatus of claim 1, said media content seek module to perform said video sequence header alignment if said time seek request includes a time value that is within a second video sequence.

4. The apparatus of claim 1, said media content seek module to perform said video sequence header alignment if said time seek request includes a time value that is within a second video sequence and is less than a predefined number of time units of a video sequence header.

5. The apparatus of claim 1, said media content seek module to perform video sequence header retransmission if said time seek request includes a time value that is within a second video sequence and is more than a predefined number of time units of a video sequence header.

6. A system, comprising:
a communications medium; and
a digital media server having a media content seek module, said media content seek module to perform video sequence header alignment for media content in response to a time seek request.

7. The system of claim 6, comprising a media server control point to provide a user interface to navigate said media content, said media server control point to send said time seek request to said digital media server.

8. The system of claim 6, comprising a digital media renderer to decode said media content received from said digital media server.

9. The system of claim 6, said media content seek module to perform group of picture header alignment if said time seek request includes a time value that is within a first video sequence.

10. The system of claim 6, said media content seek module to perform said video sequence header alignment if said time seek request includes a time value that is within a second video sequence.

11. The system of claim 6, said media content seek module to perform said video sequence header alignment if said time seek request includes a time value that is within a second video sequence and is less than a predefined number of time units of a video sequence header.

12. The system of claim 6, said media content seek module to perform video sequence header retransmission if said time seek request includes a time value that is within a second video sequence and is more than a predefined number of time units of a video sequence header.

13. A method, comprising:
receiving a time seek request; and
performing video sequence header alignment for media content in response to said time seek request.

14. The method of claim 13, comprising performing group of picture header alignment if said time seek request includes a time value that is within a first video sequence.

15. The method of claim 13, comprising performing said video sequence header alignment if said time seek request includes a time value that is within a second video sequence.

16. The method of claim 13, comprising performing said video sequence header alignment if said time seek request includes a time value that is within a second video sequence and is less than a predefined number of time units of a video sequence header.

17. The method of claim 13, comprising performing video sequence header retransmission if said time seek request includes a time value that is within a second video sequence and is more than a predefined number of time units of a video sequence header.

18. An article comprising a machine-readable storage medium containing instructions that if executed enable a system to receive a time seek request, and perform video sequence header alignment for media content in response to said time seek request.

19. The article of claim 18, further comprising instructions that if executed enable the system to perform group of picture header alignment if said time seek request includes a time value that is within a first video sequence.

20. The article of claim 18, further comprising instructions that if executed enable the system to perform said video sequence header alignment if said time seek request includes a time value that is within a second video sequence.

21. The article of claim 18, further comprising instructions that if executed enable the system to perform said video sequence header alignment if said time seek request includes a time value that is within a second video sequence and is less than a predefined number of time units of a video sequence header.

22. The article of claim 18, further comprising instructions that if executed enable the system to perform video sequence header retransmission if said time seek request includes a time value that is within a second video sequence and is more than a predefined number of time units of a video sequence header.
